(19) United States
(12) Patent Application Publication
(10) Pub. No.: US 2024/0274312 A1
(43) Pub. Date: Aug. 15, 2024

(54) MECHANICAL MODIFICATION OF NUCLEAR WASTE FOR DISPOSAL

(71) Applicant: Henry Crichlow, Norman, OK (US)

(72) Inventor: Henry Crichlow, Norman, OK (US)

(21) Appl. No.: 18/212,978

(22) Filed: Jun. 22, 2023

Related U.S. Application Data
(63) Continuation-in-part of application No. 18/108,001, filed on Feb. 9, 2023.

(51) Int. Cl. G21F 9/34

(52) U.S. Cl. CPC G21F 9/34

(57) ABSTRACT

Devices, systems, and methods for mechanical and/or physical modifications of nuclear waste forms, such as, but not limited to, spent nuclear fuel (SNF) assemblies, for disposing within deeply located geologic repositories, where such methods may include: (1) reducing a size of the original nuclear waste form(s) by feeding the original nuclear waste form(s) into specialty industrial machines, such as, but not limited to, industrial chipping machines (or the like), for size reduction to yield waste chips; (2) compressing, compacting, extruding, and/or shaping the waste chips into waste pucks by using industrial compactor machines; (3) loading the generated dense waste pucks into waste capsules; and (4) landing the waste capsules, filled with the dense waste pucks, into sections of wellbores that are located within deep geological formations.

### PRIORITY NOTICE

The present patent application, as a continuation-in-part (CIP) patent application, claims priority under 35 U.S.C. § 120 to earlier filed and copending U.S. nonprovisional patent application Ser. No. 18/108,001 filed on Feb. 9, 2023, by the same inventor as the present patent application; wherein the disclosure of U.S. nonprovisional patent application Ser. No. 18/108,001 is incorporated herein by reference in its entirety.

### CROSS REFERENCE TO RELATED U.S. PATENTS

The disclosures and teachings of U.S. utility patents 5850614, 6238138, 11289234, and 10427191, all by the same inventor as the present patent application, are all incorporated by reference as if fully set forth herein.

### TECHNICAL FIELD OF THE INVENTION

The present invention relates in general to containment, preparation, storage, and/or disposal of radioactive materials, such as, but not limited to, nuclear waste; and, more specifically, to the containment, preparation, storage, and/or disposal of mechanically modified spent nuclear fuel (SNF) assemblies and/or other radioactive waste forms into generally cylindrical capsule disposal systems, within deeply located geological formations of predetermined characteristics (such as, but not limited to predetermined rock properties) in which geological repositories may be implemented as human-made deep horizontal wellbores in rock formations located therein.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Today (circa 2023), there is a massive quantity of nuclear waste accumulating across the world, including the United States (U.S.). There are two significant sources of a majority of nuclear waste. A first source is high-level waste (HLW) from generating electric power in nuclear-fired power plants and from military nuclear operations. And the second source is low-level waste (LLW) from various industrial activities using radioactive sources and using radioactive production systems. Both sources of radioactive (nuclear) waste must be addressed, controlled, and disposed of safely. This patent application addresses one of these sources of waste and how to dispose of that waste safely and, more importantly, in a timely manner. This patent application is directed to the disposal of SNF materials so that the SNF may be disposed of safely, securely, economically, and timely.

Current and prior art disposal of SNF as HLW in vertical wellbores involves the placement of the nuclear waste within capsules, wherein the capsules containing nuclear waste are then usually placed in a bottom one-third section of a vertical wellbores. Wellbore sealing plugs have been placed above the emplaced capsules. Above these sealing plugs are various backfill materials that are designed to swell and fill the vertical wellbore. However, in practice, some structural/physical changes may occur in and at the near wellbore region between the drilled-out wellbore and the native rock formation due to the drilling process. Fissures, microfractures, and permeability changes may occur at the interface between the wellbore and into the proximate surrounding native rock, sometimes called “near-wellbore damage” in the oil drilling industry. These changes contribute to and may allow fluid bypass, migration, and movement of waste material over time out of the emplaced capsules and into the surrounding native rock.

Nuclear waste disposal in horizontal wellbores has been illustrated in some previous U.S. utility patents such as, 5850614, 6238138, 11289234, and 10427191 all by the same inventor as the present patent application. The disclosures and teachings of U.S. utility patents such as, 5850614, 6238138, 11289234, and 10427191 are all incorporated by reference as if fully set forth herein. This patent application may place encapsulated nuclear (radioactive) waste materials into lateral or horizontal wellbores.

In prior art technology and operations, two diametrically opposing approaches to treating SNF assemblies are taught. A first approach reprocesses SNF assemblies to separate plutonium and/or uranium from other nuclear waste contained in the used (or “spent”) nuclear fuel from nuclear power reactors (and the separated plutonium can be re-used to fuel reactors and/or make nuclear weapons). And the second approach disposed of SNF assemblies, intact or disassembled, as waste into deep geological repositories.

With respect to the first prior art approach of reprocessing, this reprocessing is a series of chemical operations that separates plutonium and/or uranium from other nuclear waste contained in the used (or “spent”) fuel from nuclear power reactors. FIG. 5 is a flow chart showing this prior art reprocessing method. The separated plutonium can be used to fuel reactors and/or make nuclear weapons. In the late 1970s, the U.S. decided on nuclear non-proliferation grounds not to reprocess spent fuel from U.S. power reactors but to directly dispose of it in a deep underground geologic repository where it would remain isolated from the environment for at least tens of thousands of years (at least that was the general theory).

Note, the prior art reprocessing approach does not reduce the need for storage and disposal of radioactive waste. Worse, reprocessing would make it easier for terrorists and/or bad actors to acquire nuclear weapons materials and for nations to develop nuclear weapons programs. Less than twenty (20) pounds of plutonium is needed to make a simple nuclear weapon. Whereas, stealing is nearly impossible if the plutonium remains bound in large, heavy, and highly radioactive spent fuel (SNF) assemblies (which has and is the current U.S. practice).

Moreover, outside of the U.S., commercial-scale reprocessing facilities handle so much of this material that it has proven impossible to keep track of it accurately in a safe and timely manner, making it feasible that the theft of enough plutonium to build several bombs could go undetected for years.

First, no spent fuel (SNF) storage crisis warrants such a drastic change in course to the reprocessing approach. Hardened interim storage of spent fuel (SNF) in dry casks is an economically viable and secure option for at least fifty (50) years. And deep geological storage/disposal is a viable long-term SNF assembly disposal alternative.

Second, reprocessing does not reduce the need for storage and disposal of radioactive waste, and a geologic repository would still be required. Plutonium constitutes only about one percent (1%) of the spent fuel (SNF) from U.S. reactors. After reprocessing, the remaining (up to ninety-nine percent [99%] of) material will be in several different waste forms, much of which will be radioactive. The total nuclear waste volume will have been increased by a factor of twenty (20) or more by the reprocessing, including generation of low-level waste (LLW) and plutonium-contaminated waste.

Further, the reprocessing approach is very expensive. Multiple governmental and quasi-governmental agencies and technical publications indicate that such prior art reprocessing and using plutonium as reactor fuel are also far more expensive than using uranium fuel and directly disposing of the spent fuel (SNF). Some 60,000 tons of nuclear waste have already been produced in the U.S., and existing reactors add some 2,000 metric tons of spent fuel (SNF) annually. The U.S. Energy Department recently released an industry estimate that a reprocessing plant with an annual capacity of 2,000 metric tons of spent fuel (SNF) would cost up to $20 billion to build; and the U.S. would need at least two (2) of such sized reprocessing facilities just to reprocess all its spent fuel (SNF). An Argonne National Laboratory scientist recently estimated that the cost premium for reprocessing spent fuel (SNF) would range from $0.40 to $0.60 cents per kilowatt-hour, corresponding to an extra $3 to $4.5 billion per year for the current U.S. nuclear reactor fleet. The U.S. public would end up having to pay this charge, either through increased taxes and/or higher electricity bills.

There is a need for a different and better method of SNF disposal as compared to the prior art reprocessing approach (see e.g., FIG. 5 for this prior art reprocessing approach).

Today (2023), and in the recent past (1994), the treatment and reprocessing of SNF have been reported by at least two major groups or organizations across the globe.

The first is at SELLAFIELD nuclear reprocessing operations in the United Kingdom. The SNF assemblies are mechanically “cut-up,” or fragmented, and then chemically treated to provide re-useable fissile materials. See e.g., FIG. 2A.

And the second, in France, the ORANO nuclear reprocessing operations follow a similar operational path: initial mechanical chipping/cutting is followed by chemical treatment with nitric acid of the SNF material pieces to extract the fissile materials for re-use. The nonradioactive material is then disposed of as generalized metal waste at landfills or similar systems. See e.g., FIG. 2B.

These two prior art systems have some operational processes partially incorporated in the disposal process illustrated herein in this subject patent application. However, the disposal of the SNF, as taught herein, does not include the chemical treatment of the SNF. The novel processes taught herein dispose of all the structural metal elements, along with the radioactive constituents, that together comprise an original SNF assembly, without any physical separation from each other, which is a departure from the prior art reprocessing teachings.

Based on the prior art's inherent shortcomings, there is a critical need for an effective, long-lasting, robust, repeatable, and economical method for disposing of SNF assemblies. This process precludes the need for all the expensive, time-consuming, and dangerous intermediate operations currently being used or contemplated to render the nuclear waste in a form that, eventually, still has to be buried in deep underground repositories. An approach is needed that minimizes or foregoes these complex operational steps of the prior art. To solve the above-described problems, the present invention provides systems, methods, and efforts to dispose of the nuclear waste, such as, but not limited to SNF assemblies, accumulating on the surface.

The novel approaches taught as part of this patent application provide systems, methods, and steps wherein the HLW and/or SNF assemblies waste disposal operations may go directly from the existing fuel assembly rod cooling ponds to a mechanical disintegration process and then to the underground disposal repository in deep (geologic/rock) formations with minimal additional effort.

It is to these ends that the present invention has been developed to dispose of HLW and/or SNF assemblies materials in deep human-made systems that can be effectively sealed off from the ecosphere by geological means and at great depths below the Earth's surface.

### BRIEF SUMMARY OF THE INVENTION

To minimize the limitations in the prior art, and to minimize other limitations that will be apparent upon reading and understanding the present specification, various embodiments of the present invention describe devices, systems, and methods for mechanical and/or physical modifications of nuclear waste forms, such as, but not limited to, spent nuclear fuel (SNF) assemblies for disposing within deeply located geologic repositories. In some embodiments, such a method may comprise: (1) reducing a size of the original nuclear waste form(s) by feeding the original nuclear waste form(s) into specialty industrial machines, such as, but not limited to, industrial chipping machines, for size reduction to yield waste chips; (2) compressing, compacting, extruding, and/or shaping the waste chips into dense waste pucks by using industrial compactor machines; (3) loading the generated dense waste pucks into waste capsules; and (4) landing the waste capsules, filled with the dense waste pucks, into sections of wellbores that are located within deep geological formations.

At least some embodiments of the present invention may describe systems, methods, processes, and/or steps for the long-term protection of the high-level nuclear and radioactive waste (HLW) products/materials, such as, but not limited to spent nuclear fuel (SNF) assemblies, and/or other radioactive waste forms, by providing systems, methods, processes, and/or steps to securely protect the surface environment by sealing the disposed of waste deeply located horizontal (lateral) wellbores.

Additionally, at least some embodiments of the present invention focus on satisfying a need to prepare the SNF assemblies for deep geological disposal in a manner that is safe, cost-effective, timely and allows for maximal disposal of radioactive waste materials.

At least some embodiments of the present invention may focus mechanically modifying the SNF assemblies and then implementing the modified waste form inside cylindrical waste capsule systems that are configured to receive the modified waste. This modified waste form is mechanically derived from existing SNF assemblies without any chemical modification and without separating the (metal) structural elements of a given SNF assembly from its radioactive fuel materials.

At least some embodiments of the present invention differ from the prior art SNF reprocessing method for generating nuclear fuel for reuse as nuclear fuel by one or more of the following: (1) a mechanical fragmentation, shredding and/or chipping operation of intact SNF assemblies; (2) a volume reduction process, that compacts and/or compresses the outputs from the (1) mechanical fragmentation shredding and/or chipping operations; (3) a molding and/or extruding process of the outputs from the (2) volume reduction process, wherein in this (3) process, the waste is shaped and sized into (cylindrical) elements that are specifically configured to fit within the waste capsules; and lastly (4) encapsulation and disposal of the converted nuclear waste into the waste capsules, which are then emplaced within the deeply located horizontal (lateral) wellbores.

In some embodiments, as a safety precaution, a criticality analysis may be desired, required, and/or implemented, prior to making a given waste capsule, filling a given waste capsule with nuclear (radioactive) waste, and/or emplacing a given waste capsule with nuclear (radioactive) waste within a given deeply located geological repository, to ensure no critical (nuclear) reactions occur in the nuclear waste material during processing, emplacement, and/or residency in the given deeply located geological repository. In some embodiments, a fissile criticality analysis (FCA) may be performed on the waste capsule, the nuclear (radioactive) waste itself, and on the equipment that may handle the waste capsules and/or the nuclear (radioactive) waste, to determine metrics such as, waste composition, waste type, waste density, waste weight, waste volume, waste size (dimensions), waste shape (geometry), waste capsule materials of construction, waste capsule thickness, waste capsule size (dimension), waste capsule shape (geometry), waste capsule packing of waste, quantity of packed waste capsules, formation (rock) properties of the formation (rock) that immediately surrounds a given or planned deeply located geological repository, and geometry of the disposal system and its contents such that the nuclear (radioactive) waste material always remains subcritical. In some embodiments, this FCA analysis may provide (yield) upper limits on the weight per unit of material, typically called “gram-limits,” which may be the maximum quantity of fissile material in a given waste package (waste capsule). In some embodiments, the required gram limits may be used in all the subsequent waste disposal processes. In addition, the criticality analysis (FCA) may utilize factors such as, physical volumes of waste, material burnup times, time out of the reactor, and other well-known safety metrics to define the final configuration of the waste package (waste capsule).

In some embodiments, it may be a requirement of at least one embodiment that the devices, systems, and/or methods are capable of protecting the environment from the deleterious effects of high nuclear waste disposal and waste migration away from the disposal location.

It is an objective of the present invention to allow the processing and disposing of large volumes (e.g., on the order of thousands of metric tons) of waste (e.g., HLW).

It is another objective of the present invention to allow the processing and disposing of large volumes of waste in a manner that is both safe and effective.

It is another objective of the present invention to allow the processing and disposing of large volumes of waste in a manner that is scalable.

It is another objective of the present invention to allow the processing and disposing of waste in a manner that is exponentially scalable.

It is another objective of the present invention to dispose of waste within deeply located horizontal wellbores (note such a deeply located horizontal wellbore may be referred to as a SuperLAT).

It is another objective of the present invention to dispose of waste, in different or multiple waste forms, within deeply located horizontal wellbores.

It is another objective of the present invention to provide novel means of modifying SNF assemblies to allow for disposal, efficiently, timely, economically and safely for final placement into cylindrical wellbore repositories.

It is another objective of the present invention to significantly reduce a volume of mechanically modified waste to allow for more efficient disposal in horizontal wellbore systems.

It is another objective of the present invention to allow the prepared waste material to be easily disposed of using the geometry of the cylindrical wellbores without unnecessary experimentation and modifications.

It is another objective of the present invention to significantly reduce costs of SNF assemblies disposal by utilizing available economic means of processing the waste into novel forms for disposal that may be at least partially to mostly automated.

It is another objective of the present invention to provide underground waste storage in deep-closed geological systems, zones, and/or formations.

It is another objective of the present invention to implement deep geological disposal devices, systems, and/or methods for the long-term disposal of HLW/LLW and/or derivatives, such as, but not limited to, spent nuclear fuel (SNF) assemblies into waste capsules and for disposal of solid LLW products or waste in slurry, powder, or aggregate forms.

It is another objective of the present invention to allow the processing and disposal of large volumes (e.g., on the order of thousands of metric tons) of multiple waste forms waste (e.g., HLW in horizontal wellbores [SuperLAT] systems) for disposal underground.

It is yet another objective of the present invention to implement a fissile criticality analysis (FCA) prior to making a given waste capsule, filling a given waste capsule with nuclear (radioactive) waste, and/or emplacing a given waste capsule with nuclear (radioactive) waste within a given deeply located geological repository, to ensure no critical (nuclear) reactions occur in the nuclear (radioactive) waste material during processing, emplacement, and/or residency in the given deeply located geological repository.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale to enhance their clarity and improve understanding of these various elements and embodiments of the invention. Furthermore, elements known to be common and well-understood to those in the industry are not depicted to provide a clear view of the various embodiments of the invention. Some common items are left off the drawings for clarity and ease of viewing. For example, in some instances, specific devices or apparatuses may not be shown in a given view. Still, it may be obvious to a person of ordinary skill in the relevant arts (technical fields) from the description that these items may be present and/or used in the given embodiment.

FIG. 1A is prior art and shows a Canadian model CANDU for nuclear fuel assemblies.

FIG. 1B is prior art and shows Russian nuclear fuel assemblies.

FIG. 1C is prior art and shows U.S. nuclear fuel assemblies.

FIG. 2A depicts a two-dimensional (2D) schematic of a prior art chipper system, which illustrates the type of chipping operation at the SELLAFIELD United Kingdom (U.K.) reprocessing plant for SNF assemblies.

FIG. 2B depicts a 2D schematic of a prior art chipper system, which illustrates the type of chipping operation at the ORANO reprocessing facility for SNF assemblies operating in France.

FIG. 3A may depict an isometric schematic of one type of industrial compactor machine that illustrates a type of machine capable of compacting outputs from chipper operations into more dense compacted discs or plugs.

FIG. 3B may depict a schematic of another industrial compactor machine that may operate on the compaction and extrusion principles such that the compacted material is sequentially extruded to form cylindrical plugs of compacted waste material continuously. Sometimes, such combination compaction and extruder machines may form “bricks” or briquettes geometries as the outputs from the fed inputs.

FIG. 3C may depict a schematic of another type of industrial compactor machine that may operate with a hopper to collect the waste material and a feeder system to allow the collected waste (in the hopper) to be fed to the compactor systems of industrial compactor machine on demand.

FIG. 4A shows a schematic of a waste container with the chipped nuclear waste inside.

FIG. 4B shows a schematic of the waste material inside a container being compressed or compacted by the structural elements which provide compression, compaction, and/or extrusion.

FIG. 4C shows a schematic of waste material that has been compacted, compressed, and/or extruded.

FIG. 4D shows a schematic of a waste capsule with compacted, compressed, and/or extrude waste material plugs inside of that given waste capsule.

FIG. 4E may depict an (at least partially) exploded cross-sectional close up (detailed) view of a section of a given waste capsule with a plurality of waste pucks located within that given waste capsule.

FIG. 4F shows an illustration of at least two (end-to-end) adjacent physically linked waste capsules, which in such a configuration may form a string of waste capsules, located inside of a given wellbore.

FIG. 5 may depict a flow chart of an existing prior art method of reprocessing SNF in which the SNF assemblies are chipped and processed to separate and retrieve the radioactive materials chemically from the structural elements of the SNF assemblies.

FIG. 6 may depict a flow chart of at least one step in a novel method of disposing of SNF in which the SNF assemblies are mechanically modified, loaded in waste capsules, and then disposed of in deeply located horizontal wellbores.

FIG. 7 may depict a waste disposal repository system in which waste capsules (with waste pucks) are sequestered in horizontal wellbore(s), wherein the horizontal wellbore(s) are located within deeply located geological formation(s) (wherein a waste disposal repository system that uses such horizontal wellbore(s) that are located within deeply located geological formation(s) may be referred to as a SuperLAT deep disposal system).

### REFERENCE NUMERAL SCHEDULE

With regard to the reference numerals used herein, the following numbering is used throughout the various drawing figures.
101 Canadian CANDU Spent Nuclear Fuel assembly 101
102 Russian Spent Nuclear Fuel assembly 102
103 U.S. PWR Spent Nuclear Fuel assembly 103
200 U.K. prior art chipper system for SNF assemblies 200
210 container (collector for chipped SNF material) 210
212 cutting means (blade or guillotine) 212
214 pusher for SNF 214
220 SNF assembly 220
250 French prior art chipper system 250
260 guide (for SNF assembly movement and positioning) 260
299 chipped SNF material (output from chipper) 299
300 industrial high-capacity compactor machine/system 300
310 hydraulic subassembly of compactor/extruder 310
320 container (for chipped SNF material) 320
330 disc (or plug) (of compacted waste) 330
350 extruder type compactor machine 350
360 subassembly 360
370 extruder subassembly 370
380 disc (or plug) (of compacted waste) 380
390 plurality of waste discs or plugs 390
390 industrial high-capacity compactor machine/system 390
391 compactor system 391
392 feeder (conveyor) 392
393 waste feed hopper 393
394 compactor controller 394
401 container (for collected chips) 401
402 compactor rod (arm) 402
403 compactor piston (ram) 403
404 compactor cylinder sidewall 404
405 waste puck 405
406 capsule connector device 406
407 capsule coupling device 407
408 capsule sidewall 408
409 waste capsule 409
410 (neutron absorbing/shielding) separator plate(s) 410
411 (neutron absorbing/shielding) sheath 411
414 string of waste capsules 414
415 deeply located geologic formation (rock) 415
500 prior art method of reprocessing SNF assemblies 500
501 step of collecting SNF assemblies 501
503 step of chipping/cutting SNF assemblies into chips 503
505 step of treating the chipped material in nitric acid to separate the fuel materials from structural elements of assembly 505
507 step of chemical processing nitric acid solution to obtain radioactive fuel products 507
509 step of reprocessing recovered radioactive products for reuse in nuclear power generation 509
511 step of collecting the undissolved structural assembly elements 511
513 step of landfilling or recycling the structural assembly elements 513
600 method of mechanical processing and/or disposing of SNF including SNF assemblies 600
601 step of collecting SNF assemblies and/or transporting SNF assemblies to processing site(s) 601
603 availability of various chipper, cutter, knife, circular saw, grinding, tearing, laser cutting, or the like systems 603
605 step of chipper operations on SNF assemblies under fluid stream 605
607 step of collecting chipped material (and preparation for compaction) 607
609 step of implementing deep geological repository with horizontal wellbores (for sequestering nuclear waste capsules) 609
611 step of compacting chips using high-capacity (hydraulic) compactors (to reduce waste volume and to form cylindrical waste pucks) 611
613 step of loading waste plugs into waste capsules 613
615 step of (transporting and) loading waste capsules into waste repository 615
617 step of sealing previously loaded waste repository 617
619 step of (optionally) retrieving waste capsules from deep geological waste repository 619
700 waste disposal system 700
701 horizontal (lateral) wellbore(s) 701
703 vertical wellbore(s) 703
705 terrestrial (Earth) surface 705
707 drilling rig 707
709 nuclear power generation reactor plant 709
711 infrastructure building or structure 711
713 seal (plug) 713

### DETAILED DESCRIPTION OF THE INVENTION

In this patent application, the term “HLW” refers to high-level nuclear waste, which is radioactive. In this patent application, the term “SNF” refers to spent nuclear fuel and is a type of HLW. In this patent application, the terms “HLW” and “SNF” may be used interchangeably.

In this patent application, the terms “wellbore” and “borehole” may be used interchangeably. Note, unless “wellbore” is prefaced with “vertical,” “horizontal,” or “lateral,” then use of “wellbore” alone may refer to a vertical wellbore, a horizontal wellbore, and/or a lateral wellbore.

In this patent application, the terms “capsule,” “carrier tube,” and “canister” may be used interchangeably with the same meaning referring to capsule that is configured to house, hold, and/or retain waste therein, such as, but not limited to, nuclear waste, radioactive waste, HLW, SNF, SNF assemblies, portions thereof, combinations thereof, and/or the like.

In this patent application, the terms “chip,” “chipped,” “fragment,” “cut-up,” and/or “shred” may be used interchangeably to refer portions of waste that are the outputs from mechanical modification means that have cut, chopped, and/or ground waste into smaller (solid) pieces.

In this patent application, the terms “tube,” “cylinder,” and “pipe” may be used interchangeably to refer to cylindrical elements implemented in the design and/or installation processes of some embodiments of the present invention.

In this patent application, the terms “plug” and “disc” may be used interchangeably and refer to three-dimensional (3D) (cylindrical) elements (members) formed by compression, compaction, and/or by extrusion the chip waste into a further smaller piece.

In some embodiments, use of appropriate personal protective equipment, appropriate protective equipment for machinery, and/or appropriate practices (protocols) with respect to ionizing radiation, radioactive materials, and/or radioactive contamination may be contemplated, implemented, and/or used. In some embodiments, any dangerous waste material may be remotely handled, appropriately safeguarded, and/or handled and/or transported under (U.S. federally) licensed means to protect workers.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

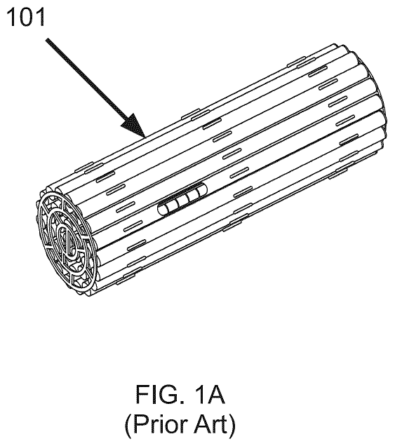

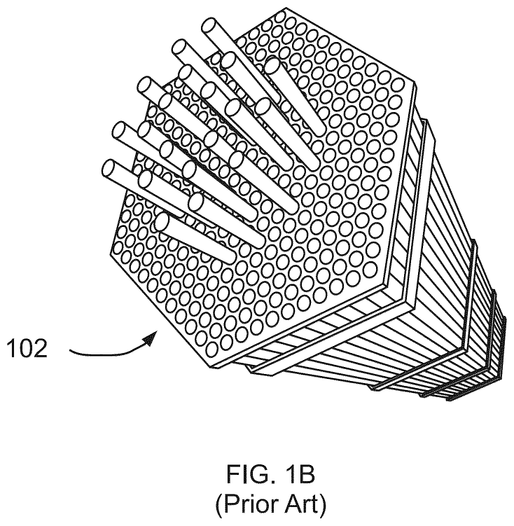

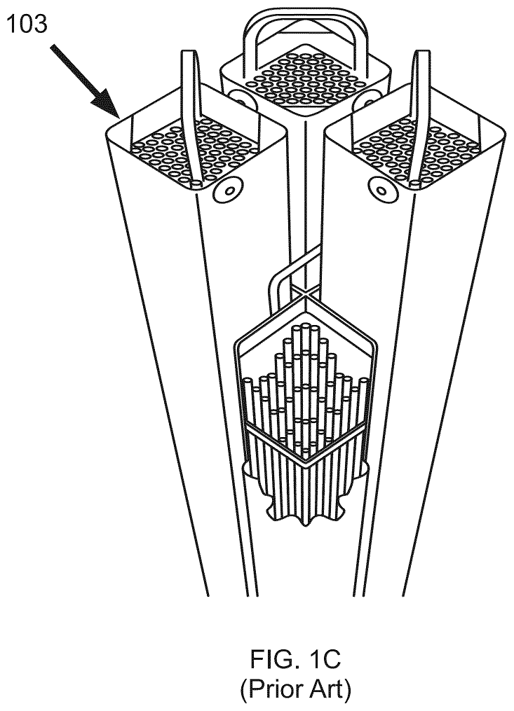

FIG. 1A, FIG. 1B, and FIG. 1C may collectively illustrate types of prior art preexisting and current nuclear fuel assemblies 101, 102, and 103, at least used in Canada, Russia, and the U.S., respectively. These nuclear fuel assemblies 101, 102, and 103 vary in size and shape in actual practice and have been specifically designed to optimize performance during power generation. Some nominal dimensions of these types of nuclear fuel rod assemblies 101, 102, and 103 may be as follows: (a) square or rectilinear fuel rod assemblies 103 are usually between four (4) meters (m) to five (5) meters in length and about fourteen (14) centimeters (cm) to twenty-two (22) cm in cross-section; and (b) nominal dimensions of the circular fuel rod assemblies 101 are about fifty (50) cm long and about ten (10) cm in cross-section. In any event, as these nuclear fuel assemblies 101, 102, and/or 103, are prior art and existing, the precise dimensions and geometries are known.

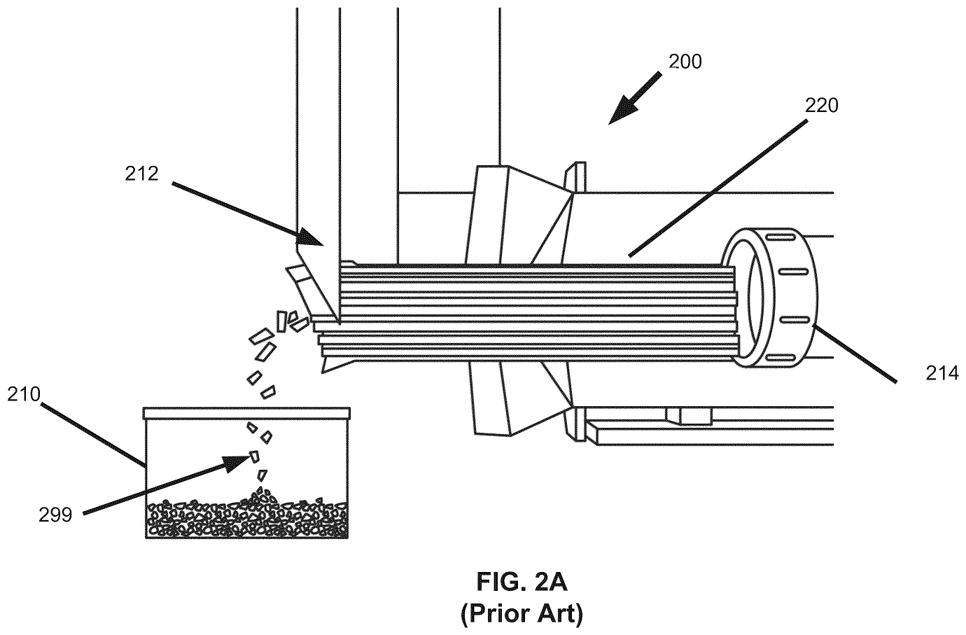

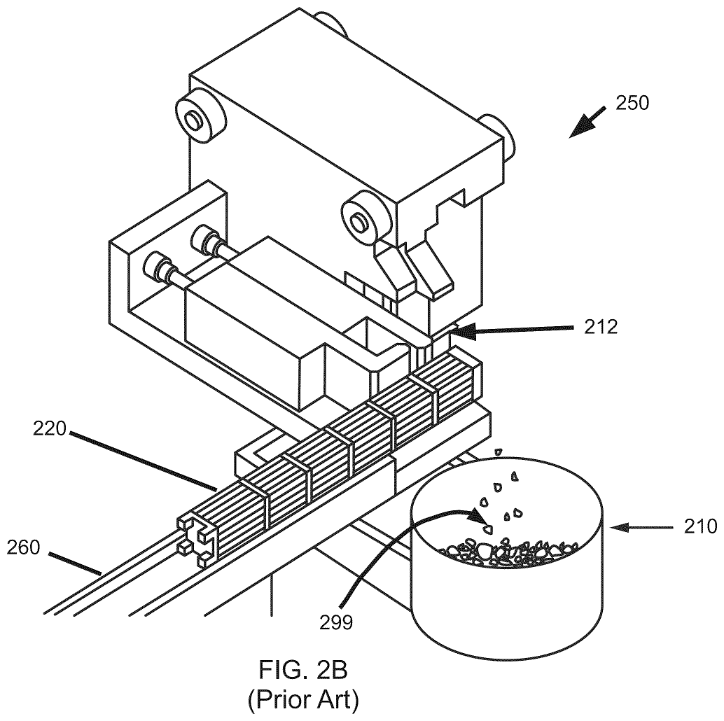

FIG. 2A illustrates a prior art process practiced by the SELLAFIELD company in the United Kingdom (U.K.) for reprocessing of SNF assemblies 220 in which the SNF assemblies 220 that have been removed from cooling ponds (at the nuclear power plants or from other [surface] storage systems) are chipped by a chipper machine 200 into chipped SNF material 299. In this operation depicted in FIG. 2A, a pusher mechanism 214 may force the SNF assembly 220 forward linearly into a guillotine 212 or the like cutting means, which vertically chips or cuts the SNF assembly 220 into prescribed length pieces of chipped SNF material 299. The chipped SNF material 299 is collected in a container 210.

FIG. 2B illustrates a prior art process practiced by the ORANO company in France for reprocessing SNF assemblies 220. The SNF assemblies 220 removed from the cooling ponds (at the nuclear power plants or other [surface] storage systems) are fragmented by a chipper machine 250. In this operation depicted in FIG. 2B, a guide mechanism 260 allows the SNF assembly 220 to move forward linearly to a guillotine 212 or the like cutting means which cuts the SNF assembly 220 into prescribed length pieces of chipped SNF material 299. The chipped SNF material 299 is collected in container 210. In practice, the chipping of the SNF assemblies 220 may take place under circulating water or a fluid stream.

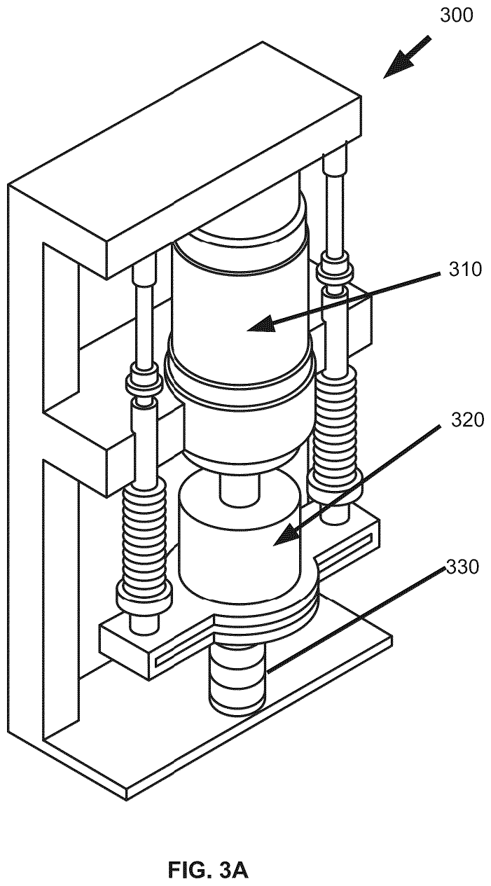

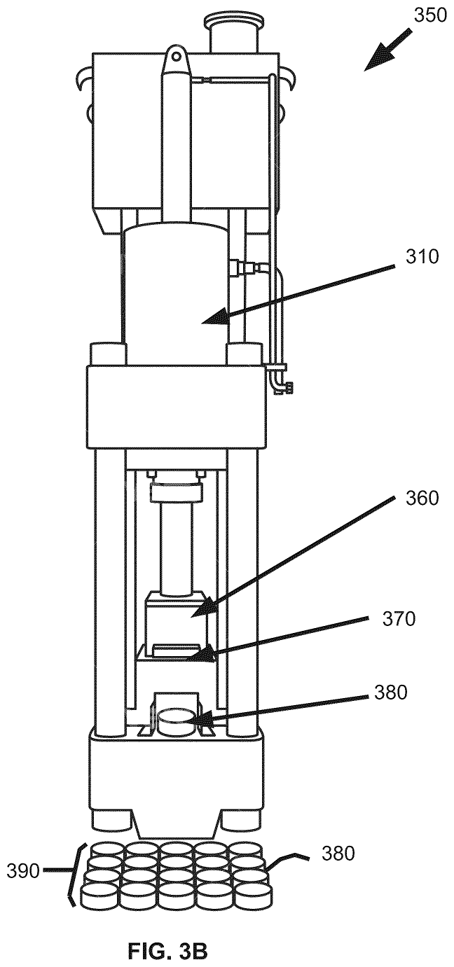

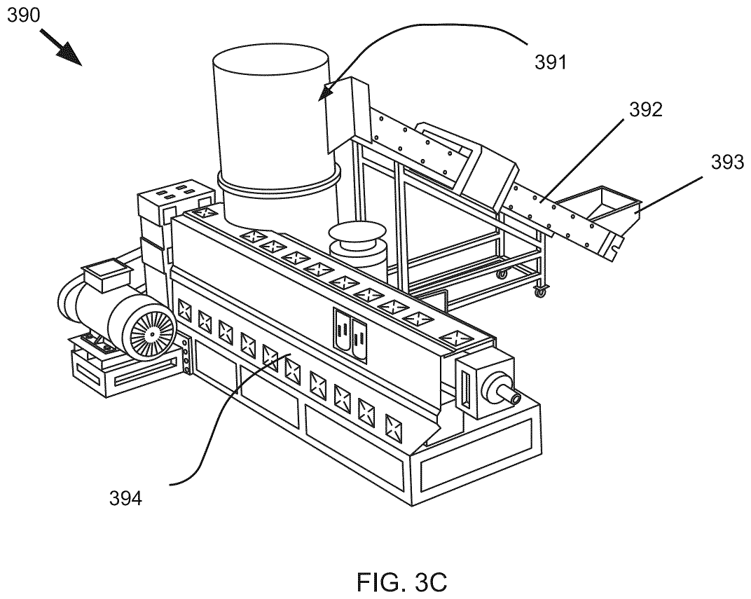

FIG. 3A may depict an isometric schematic of one type of industrial compactor system and/or machine 300 that may be configured for directly compacting the chipped SNF material 299 into compressed, compacted, and/or extruded denser flattened discs 330 (or plugs 330). In some embodiments, reference numeral “310” may represents a hydraulic system and its accessory (collateral) features (components), of industrial compactor system and/or machine 300, that generate the necessary compression, compacting, clamping, and/or extrusion forces to compress, compact, and/or extrude the chipped SNF material 299 into discs 330. In some embodiments, discs 330 may be denser, more compacted, more compressed, and/or intentionally shaped (e.g., as a cylindrical disc member) as compared to the chipped SNF material 299. In some embodiments, in FIG. 3A, container (cylinder) 320 encloses the feed stock material of chipped SNF material 299, which is then compressed, compacted, and/or extruded by the hydraulic subassembly of compactor/extruder 310, into the desired compression level of discs 330. In some embodiments, with respect to industrial compactor system and/or machine 300, chipped SNF material 299 may be the feed input into industrial compactor system and/or machine 300, and discs 330 may be the output from industrial compactor system and/or machine 300 operations. In some embodiments, industrial compactor system and/or machine 300 may comprise hydraulic subassembly of compactor/extruder 310 and/or container (cylinder) 320.

FIG. 3B may depict an isometric schematic of one type of industrial compactor system and/or machine 350 that may be configured for directly compacting the chipped SNF material 299 into compressed, compacted, and/or extruded denser flattened discs 380 (or plugs 380); and, at a same time, on-demand, sequentially extruding the compacted dense waste into flattened discs 380. The system/machine 350 depicted in FIG. 3B may continuously feed the chipped SNF material by a feeder system that is not shown in FIG. 3B. This feeder feature addition allows for more efficient and rapid modification of the chipped SNF material 299 feed since the production of discs 380 may run automatically and continuously, as long as the chipped SNF material 299 exists to be modified and not including maintenance downtime.

Continuing discussing FIG. 3B, in some embodiments, reference numeral “310” of FIG. 3B and/or of system/machine 350 may represent a hydraulic system and its accessory (collateral) features (components), of industrial compactor system and/or machine 350, that generates the necessary compression, compacting, clamping, and/or extrusion forces to compress, compact, and/or extrude the chipped SNF material 299 into discs 380. In some embodiments, discs 380 may be denser, more compacted, more compressed, and/or intentionally shaped (e.g., as a cylindrical disc member) as compared to the chipped SNF material 299.

In some embodiments, during operation of extruder type compactor machine 350, sub-assemblies 360 and 370 may selectively and/or continuously extrude the chipped SNF material 299 into the outputted compressed, compacted, extruded, and/or shaped discs 380 (or in some cases, outputted as bricks or briquettes). In FIG. 3B, the compacted or extruded waste discs 380 may be collected as a plurality of waste discs 390.

In some embodiments, extruder type compactor machine 350 may have and/or may comprise an added feeder system, not shown, to continuously load the chipped SNF material 299 into the extruder type compactor machine 350 assembly.

In some embodiments, compactor machine 300, compactor machine 350, combinations thereof, and/or the like may have an applied compressive force capacity of 2,600 metric tons (mt) or more.

In some embodiments, compactor machine 300, compactor machine 350, combinations thereof, and/or the like may compress and/or compact the feed material (such as, but not limited to, the chipped SNF material 299) to at least twenty percent (20%) plus or minus (+/−) five percent of (5%) of the original (non-compressed) volume.

FIG. 3C may depict a schematic illustration of another type of industrial compactor 390 that may be configured for compacting the chipper waste 299 (chipped SNF material 299). In some embodiments, with respect to industrial compactor 390, a feeder system 392 (e.g., a conveyer, belt conveyor, screw (worm) conveyor, and/or the like) may pull (draw) chipped SNF material 299 from a hopper 393 (or the like), to convey (deliver and/or transport) the chipped SNF material 299 to the compactor systems 391 of industrial compactor 390, which may then be outputted as waste pucks 405. In some embodiments, this industrial compactor 390 may have an integrated and/or connected feeder system 392 which may allow continuous feeding of chipped SNF material 299 to the compactor systems 391 of industrial compactor 390, as long as chipped SNF material 299 may be available and industrial compactor 390 is not down for maintenance. In some embodiments, chipped SNF material 299 may be placed in waste hopper 393 before being moved by the feeder 392 all under the control of a system controller 394 (or the like). In some embodiments, the feeder-hopper system 392/393 may receive chipped SNF material 299 from various shredders/chippers 200 and/or 250 (and/or the like) upstream of industrial compactor 390.

In some embodiments, the features, elements, members, portions thereof, combinations thereof, and/or the like of industrial high-capacity compactor machine/system 300, extruder type compactor machine 350, and/or industrial compactor 390 may be combined. See e.g., FIG. 3A, FIG. 3B, and FIG. 3C.

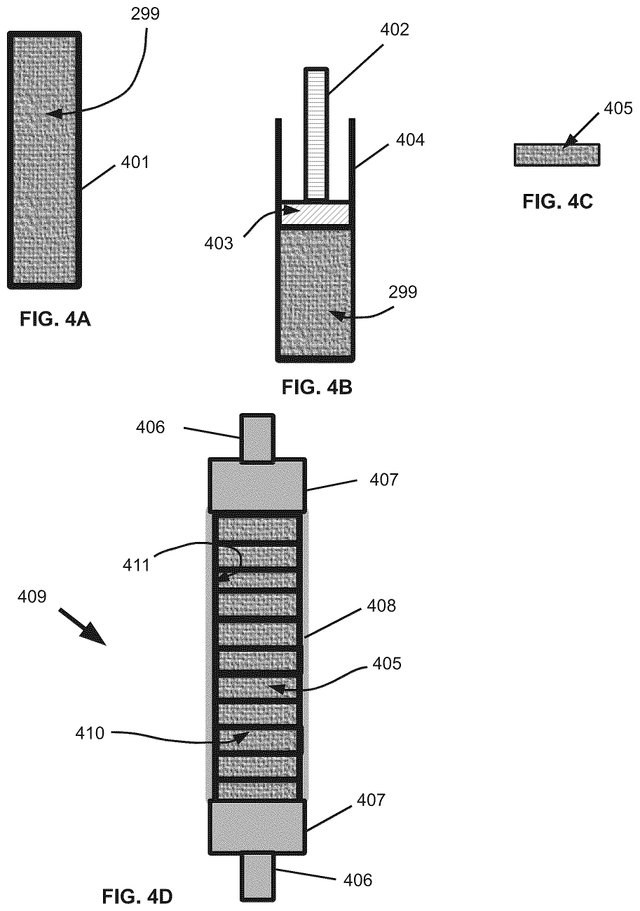

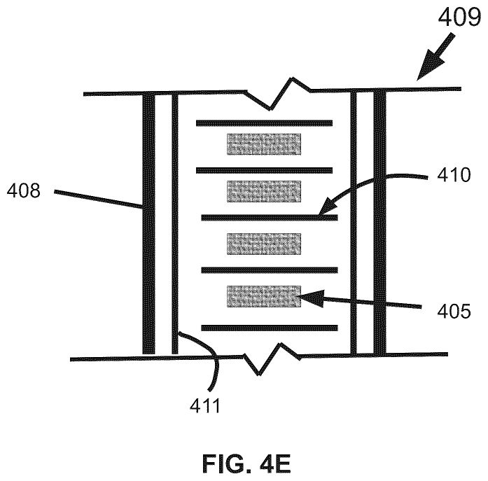

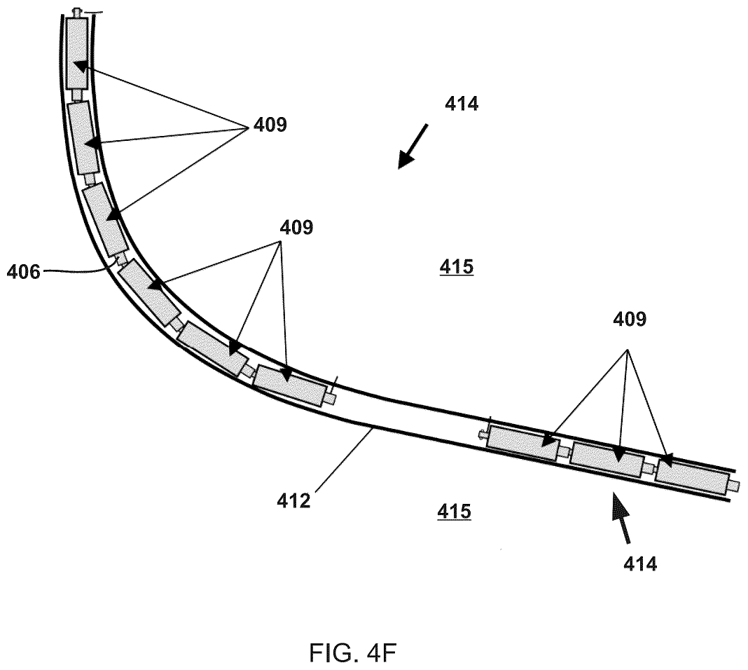

FIG. 4A, FIG. 4B, FIG. 4C, and/or FIG. 4D may illustrate at least some of a sequence of operations for further modifying the chipped SNF material 299 into waste puck(s) 405 and then for loading waste pucks 405 in a given waste capsule 409.

FIG. 4A shows a container 401 configured for collecting and/or (temporarily) holding chipped SNF material 299 produced by the chipping process (such as, but not limited to, chipper machine 200, chipper machine 250, or the like). In some embodiments, container 401 and container 210 may be used interchangeably.

FIG. 4B is a cross-sectional block diagram showing the compression and/or compaction processes that may be applied to the chipped SNF material 299. In some embodiments, FIG. 4B may show the compression and/or compaction processes, at least partially occurring within compactor machine 300 and/or within extruder and compactor machine 350, as applied to the chipped SNF material 299. FIG. 4B shows a compactor rod (arm) 402 attached to and/or in physical communication with a compactor piston (ram) 403, wherein both compactor rod (arm) 402 and compactor piston (ram) 403 may fit (concentrically) within a compactor sidewall 404. In some embodiments, compactor sidewall 404 may be at least substantially (mostly) cylindrical in shape. During compression and/or compaction operations, compactor rod (arm) 402 may press against compactor piston (ram) 403, and then compactor piston (ram) 403 may press the chipped SNF material 299, within compactor sidewall 404, and against compactor sidewall 404 resulting in compression, compaction, and/or shaping of the chipped SNF material 299 into an output of the waste puck(s) 405. In some embodiments, before and/or during compression and/or compaction operations, at least some (predetermined) quantity of the chipped SNF material 299 may be disposed between compactor piston (ram) 403 and interior surfaces of compactor sidewall 404. The compactor rod (arm) 402, the compactor piston (ram) 403, and the compactor sidewalls 404 may be more rigid and/or structurally stronger than the chipped SNF material 299. The compactor rod (arm) 402, the compactor piston (ram) 403, and the compactor sidewalls 404 may together generate sufficient compressive loads to compress and/or compact the chipped SNF material 299 into waste puck(s) 405. The compactor sidewalls 404 are sturdy enough to resist the compressive loads of the compactor rod (arm) 402 and the compactor piston (ram) 403.

In some embodiments, the compactor rod (arm) 402, the compactor piston (ram) 403, and/or compactor sidewalls 404 may be components and/or portions of hydraulic subassembly of compactor/extruder 310, container 320, subassembly 360, and/or extruder subassembly 370. See e.g., FIG. 4B, FIG. 3A, and FIG. 3B.

FIG. 4C illustrates cross-section through one single waste puck 405. In some embodiments, waste puck(s) 405 may be an output(s) from the compression and/or compaction operations of FIG. 4B, FIG. 3A, and/or FIG. 3B. In some embodiments, waste puck(s) 405 may be derived from modifying the chipped SNF material 299, such as, but not limited to, compressing, compacting, extruding, and/or shaping processes. In some embodiments, waste puck(s) 405 may be denser, more compressed, more compacted, extruded, and/or more (cylindrically) shaped as compared to the chipped SNF material 299 (which has only been chipped, cutup, ground up, and/or the like). In some embodiments, “waste puck 405,” “disc 330,” and/or “plug 380” may be used interchangeably.

FIG. 4D shows a cross-sectional block diagram through a waste capsule 409 that has been loaded with a plurality of waste pucks 405. In some embodiments, waste capsule 409 may be a capsule that is configured for receiving, housing, and/or holding a predetermined quantity, mass, weight, and/or volume of one or more of: HLW, SNF, a SNF assembly, the chipped SNF material 299, discs 330, discs 380, waste pucks 405, portions thereof, combinations thereof, and/or the like. In some embodiments, waste capsule 409 may be a capsule that is configured for receiving, housing, and/or holding a predetermined quantity, mass, weight, and/or volume of one or more of: discs 330, discs 380, waste pucks 405, portions thereof, combinations thereof, and/or the like. In some embodiments, waste capsule 409 may be an elongate cylindrical member, rigid, and/or structural. In some embodiments, waste capsule 409 may comprise two opposing terminal ends. In some embodiments, prior to loading, an interior of waste capsule 409 may be at least substantially hollow of free void space (volume). In some embodiments, waste capsules 409 may be configured to be inserted and/or landed into wellbores that may extend from a terrestrial (Earth) surface and into deeply located geological formation(s), so that the waste capsules 409 may be emplaced with deeply located geological formation(s), via use of the wellbores. FIG. 4D shows a plurality of waste pucks 405 loaded within sidewalls 408 of waste capsule 409. In some embodiments, each opposing terminal end of the capsule sidewalls 408 may be capped with a given capsule coupling device 407. In some embodiments, each opposing terminal end of the capsule sidewalls 408 may be closed off and/or sealed (such as, but not limited to, by capsule coupling devices 407 or portions thereof). In some embodiments, attached to each end of a given capsule coupling device 407 may be at least one capsule connector device 406. Thus, one given waste capsule 409 may comprise two (2) oppositely disposed capsule connector devices 406. In some embodiments, any two waste capsules 409 that are aligned end to end (e.g., with one terminal end of one waste capsule 409 next to one terminal end of a different waste capsule 409) may be mechanically joined (linked) together via mechanical interactions of their two closest capsule connector devices 406 from each of the two different waste capsules 409 (see e.g., FIG. 4F). Thus, two or more waste capsules 409 may be mechanically linked together to form a string of such waste capsules 409. In some embodiments, such a string of such waste capsules 409 may be loaded, landed, inserted, and/or emplaced within a given wellbore, wherein that given wellbore may extend into at least one deeply located geological formation.

Continuing discussing FIG. 4D, in some embodiments, a given waste capsule 409 may comprise at least one separator plate 410 and/or at least one sheath 411. Note, FIG. 4E depicts a closer up (detailed) view of a section of a given waste capsule 409 that may comprise the at least one separator plate 410 and/or the at least one sheath 411 to show these elements (members and/or components) in better detail as compared to FIG. 4D.

In some embodiments, as a safety precaution, a criticality analysis may be desired, required, and/or implemented, prior to making a given waste capsule 409, filling a given waste capsule 409 with nuclear (radioactive) waste (such as, but not limited to, chipped SNF material 299 and/or waste puck(s) 405), and/or emplacing a given waste capsule 409 with nuclear (radioactive) waste within a given deeply located geological repository 415, to ensure no critical (nuclear) reactions occur in the nuclear waste material during processing (e.g., from FIG. 2A to FIG. 4E), pre-emplacement, emplacement, residency (post-emplacement) in the given deeply located geological repository 415, and/or retrieval from the wellbore(s) 701, 703, and/or 412 from within the given deeply located geological repository 415. In some embodiments, a fissile criticality analysis (FCA) may be performed on the waste capsule 409; on waste capsule 409 components (such as, but not limited to, separator plates 410 and/or sheaths 411); the nuclear (radioactive) waste itself (such as, but not limited to, SNF, HLW, chipped SNF material 299, and/or waste pucks 405); and/or on the equipment that may handle the waste capsules 409 and/or that may handle the nuclear (radioactive) waste, to determine metrics such as, waste composition; waste type; waste density; waste weight; waste volume; waste size (dimensions); waste shape (geometry); waste puck 405 composition; waste puck 405 type; waste puck 405 density; waste puck 405 weight; waste puck 405 volume; waste puck 405 size (dimensions); waste puck 405 shape (geometry); waste capsule 409 materials of construction; waste capsule 409 thickness; waste capsule 409 size (dimension); waste capsule 409 shape (geometry); waste capsule 409 packing of waste; quantity of packed waste capsules 409; separator plates 410 materials of construction; separator plates 410 thickness; separator plates 410 size (dimension); separator plates 410 shape (geometry); separator plates 410 quantity per a given waste capsule 409; separator plates 410 placement locations within a given waste capsule 409; sheaths 411 materials of construction; sheaths 411 thickness; sheaths 411 size (dimension); sheaths 411 shape (geometry); sheaths 411 quantity per a given waste capsule 409; sheaths 411 placement location within a given waste capsule 409; formation (rock) properties of the formation (rock) 415 that immediately surrounds a given or planned deeply located geological repository 700; and/or geometry of the disposal system 700 and its contents such that the nuclear (radioactive) waste material always remains subcritical. In some embodiments, this FCA analysis may provide (yield) upper limits on the weight per unit of material, typically called “gramlimits,” which may be the maximum quantity of fissile material in a given waste package (waste capsule 409). In some embodiments, the required gram limits may be used in all the subsequent waste disposal processes. In addition, the criticality analysis (FCA) may utilize factors such as, physical volumes of waste, material burnup times, time out of the reactor, and other well-known safety metrics to define the final configuration of the waste package (waste capsule). Execution of FCA is well known in the industry and such FCA industry teachings are incorporated by reference as if fully set forth herein.

FIG. 4E illustrates an (at least partially) exploded cross-sectional close up (detailed) view of a section of a given waste capsule 409 with a plurality of waste pucks 405 located within that given waste capsule 409. In some embodiments, a given waste capsule 409 may comprise at least one separator plate 410 and/or at least one sheath 411. In some embodiments, a given waste capsule 409 with at least two (2) waste pucks 405 located within that given waste capsule 409 may comprise at least one separator plate 410 and/or at least one sheath 411. In some embodiments, a given waste capsule 409 with at least one (1) waste puck 405 located within that given waste capsule 409 may comprise at least one sheath 411. In some embodiments, two or more waste pucks 405 may be stacked on top of each other within a given waste capsule 409, such that the thicknesses of the waste pucks 405 are stacking (e.g., similar to how Ritz crackers are stacked within a sleeve or Pringles chips are stacked within a can of Pringles chips). However, in some embodiments, a separator plate 410 may be a mechanical and/or structural separator that may be located between any two adjacent waste pucks 405, within a given waste capsule 409, such that those any two adjacent waste pucks 405 cannot physically touch each other. In some embodiments, a given separator plate 410 may physically separate at least two waste pucks 405 within the given waste capsule 409 from touching each other; however, in some embodiments, not every pair of adjacent waste pucks 405 will have a separator plate 410 located there between. In some embodiments, separator plate(s) 410 may be at least partially made from neutron absorbing material(s). In some embodiments, separator plate 410 may be configured to be neutron absorbing. In some embodiments, separator plate 410 may be configured to protect elements, members, and/or components of waste capsule 409 or outside of waste capsule 409, from neutron emissions and/or neutron bombardment that may be originating from waste pucks 405 located within a given waste capsule 409. In some embodiments, a given separator plate 410 may be at least substantially (mostly) shaped as a cylindrical disc member. In some embodiments, a given separator plate 410 may be at least substantially (mostly) shaped as a solid cylindrical disc member. In some embodiments, a given separator plate 410 may be at least substantially (mostly) shaped as a solid cylindrical disc member that is free of hole(s) and/or aperture(s). In some embodiments, a given separator plate 410 may be at least substantially (mostly) made of/from borated steel and/or some similar type neutron absorbing material. In some embodiments, material(s) of construction, a quantity, a shape (geometry), dimensions, and/or specific positional locational placement within a given waste capsule 409 that is housing two or more waste pucks 405, of the neutron-protective separator plate(s) 410 may be determined from the waste material fissile critical analysis (FCA) discussed earlier.

Continuing discussing FIG. 4E, in some embodiments, sheath 411 may be a sleeve member that wraps around peripheral, circumferential, and/or outside edges/surfaces of waste pucks 405 located within a given waste capsule 409. In some embodiments, sheath 411 may be a sleeve member that may be located inside of capsule sidewall 408 within a given waste capsule 409. In some embodiments, sheath 411 may be a sleeve member that may be located inside of capsule sidewall 408 within a given waste capsule 409, but outside of any waste puck(s) 405 located within that given waste capsule 409. In some embodiments, sheath 411 may be disposed between capsule sidewall 408 and waste pucks 405; and that sheath 411 may also be located within the given waste capsule 409. In some embodiments, when sheath 411 may be wrapped around the peripheral, circumferential, and/or outside edges/surfaces of waste pucks 405 located within a given waste capsule 409, then sheath 411 may have a shape that is at least substantially (mostly) of a hollow cylindrical member (with the waste pucks 405 located within that hollow space). In some embodiments, sheath 411 may be at least partially made from neutron absorbing material(s). In some embodiments, sheath 411 may be configured to be neutron absorbing. In some embodiments, sheath 411 may be configured to protect elements, member, and/or components of waste capsule 409 or outside of waste capsule 409, from neutron emissions and/or neutron bombardment that may be originating from waste pucks 405 located within a given waste capsule 409. In some embodiments, sheath 411 may be at least partially made from borated steel (steel containing boron) and/or other neutron absorbing material(s). In some embodiments, material(s) of construction, a quantity, a shape (geometry), dimensions, and/or specific positional locational placement within a given waste capsule 409 that is housing waste puck(s) 405, of the neutron-protective sheath 411 may be determined from the waste material fissile critical analysis (FCA) discussed earlier. In some embodiments, sheath 411 may be rigid to semi-rigid.

In some embodiments, waste puck(s) 405, within a given waste capsule 409, may be surrounded by neutron absorbing (and/or resistant) material(s). See e.g., separator plate(s) 410 and/or sheath 411 in FIG. 4D and/or in FIG. 4E. In some embodiments, separator plate(s) 410 and/or sheath 411 may be configured for neutron shielding and/or neutron absorption.

FIG. 4F shows an illustration of at least two (end-to-end) adjacent physically linked waste capsules 409, which in such a configuration may form a string of waste capsules 414, located inside of a given wellbore 412. In some embodiments, at least a portion of that wellbore 412 may be located within at least one deeply located geologic formation (rock) 415. In some embodiments, any two waste capsules 409 that may be adjacently aligned end to end (e.g., with one terminal end of one waste capsule 409 next to one terminal end of a different waste capsule 409) may be mechanically joined (linked) together via mechanical interactions of their two closest capsule connector devices 406 from each of the two different waste capsules 409. Thus, two or more waste capsules 409 may be mechanically linked together to form a string of waste capsules 414. In some embodiments, such a string such waste capsules 414 may be loaded, landed, inserted, and/or emplaced within a given wellbore 412, wherein that given wellbore 412 may extend into at least one deeply located geological formation (rock) 415. In some embodiments, via mechanically interacting capsule connector devices 406, at least two non-linked, but end-to-end adjacent waste capsules 409, may be (removably) coupled (linked and/or attached) together (e.g., to form a given string of waste capsules 414 or to become part of an existing string of waste capsules 414). In some embodiments, at least two non-linked, but end-to-end adjacent waste capsules 409, may be coupled (linked and/or attached) together, within or outside of a given wellbore 412, to form a given string of waste capsules 414 or to become part of an existing string of waste capsules 414. In some embodiments, at least two linked waste capsules 409 within a given string of waste capsules 414, may be decoupled. In some embodiments, at least two linked waste capsules 409 within a given string of waste capsules 414, may be decoupled, within or outside of a given wellbore 412.

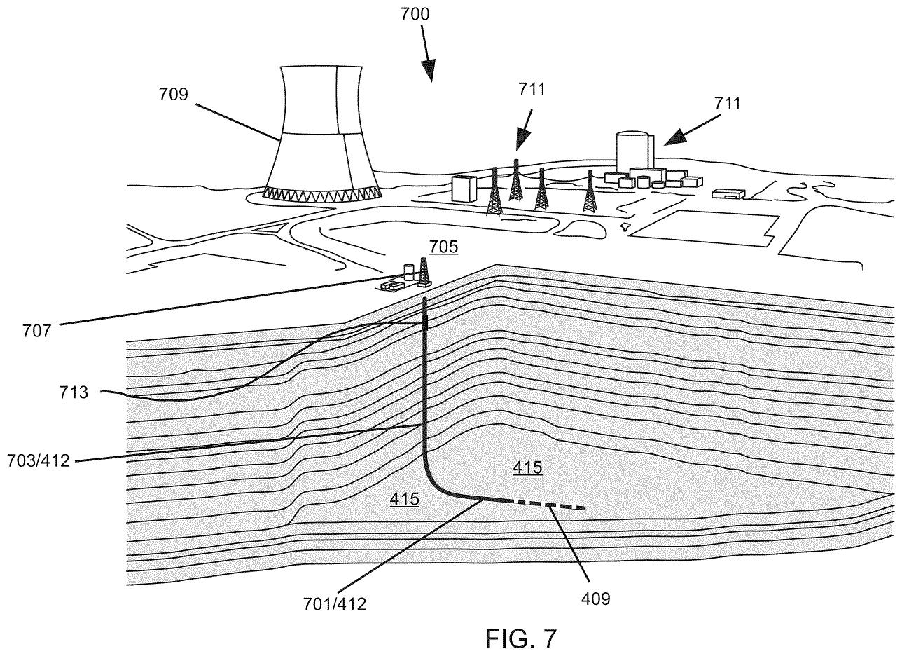

Continuing discussing FIG. 4F, in some embodiments, wellbore 412 may comprise at least substantially (mostly) vertical sections, horizontal sections (lateral sections), transitional sections, portions thereof, combinations thereof, and/or the like. In some embodiments, the at least substantially (mostly) vertical sections, horizontal sections (lateral sections), transitional sections, portions thereof, combinations thereof, and/or the like, of a given wellbore 412 may be operatively connected to each other. In some embodiments, the at least substantially (mostly) vertical sections, horizontal sections (lateral sections), transitional sections, portions thereof, combinations thereof, and/or the like, of a given wellbore 412 may be integral to each other. See also, FIG. 7.

In some embodiments, handling waste capsule(s) 409 and/or string(s) of waste capsule(s) 414, within wellbore(s) 412, may be accomplished using tools, tooling, machines, devices, apparatus, systems, methods, processes, and/or techniques of the oil field industry that are in use today and well understood. Such preexisting downhole tools, tooling, machines, devices, apparatus, systems, methods, processes, and/or techniques of the oil field industry are incorporated by reference herein as if fully set forth herein.

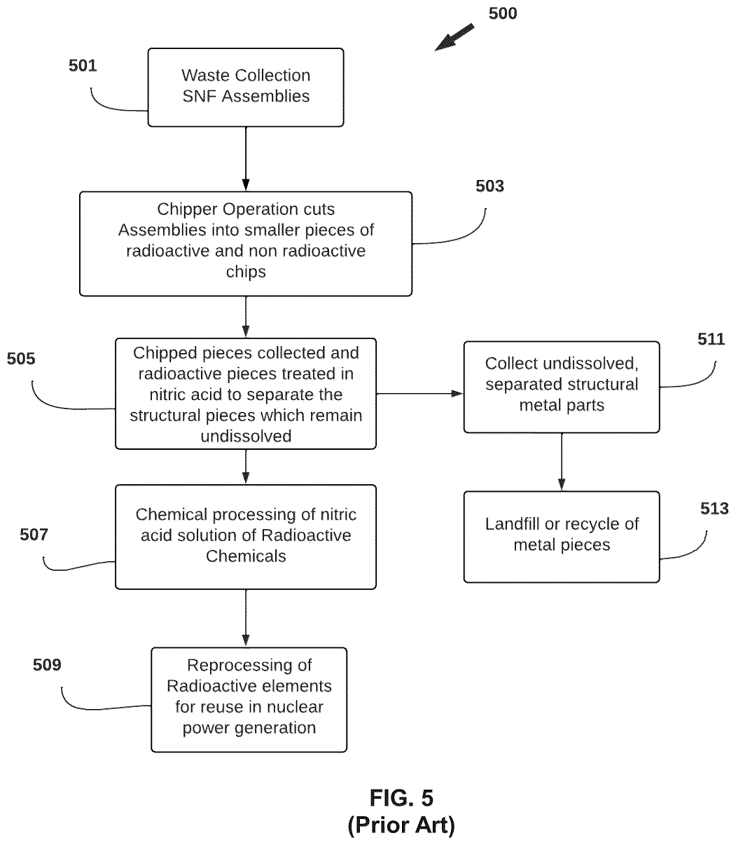

FIG. 5 depicts steps in a prior art method 500 of reprocessing SNF assemblies (such as, SNF assemblies 101, 102, and/or 103) for a goal of recovering and/or providing usable fissile HLW nuclear materials to be reused as nuclear fuel in nuclear power generating reactors. Such SNF assemblies reprocessing has been used in the U.K. and in France. Method 500 includes steps of step 501, step 503, step 505, step 507, step 509, step 511, and step 513.

Continuing discussing FIG. 5, step 501 is a step of collecting SNF assemblies (such as, SNF assemblies 101, 102, and/or 103) for use in method 500. These SNF assemblies (such as, SNF assemblies 101, 102, and/or 103) are in temporary storage in cooling ponds or in surface storage in dry cask containers. After execution of step 501, method 500 progresses to step 503.

Continuing discussing FIG. 5, step 503 is a step of chipping and/or cutting up the collected SNF assemblies (such as, SNF assemblies 101, 102, and/or 103) into chips or fragments. In step 503, the SNF assemblies (such as, SNF assemblies 101, 102, and/or 103) are mechanically fragmented into smaller particulate matter, chipped SNF material 299. In the prior art, this step 503 fragmentation process is done by chipper, cutter, saw, or other similar means of cutting the SNF assemblies (such as, SNF assemblies 101, 102, and/or 103). At the end of step 503, the outputted material, chipped SNF material 299. After execution of step 503, method 500 progresses to step 505.

Continuing discussing FIG. 5, step 505 is a step of treating the chipped materials output from step 503 with nitric acid to separate the nuclear fuel materials from the structural elements of the SNF assemblies that have been cutup and/or chipped. In step 505, the SNF assembly particulate material, the chipped SNF material 299, is chemically treated in nitric acid to dissolve the radioactive materials, which leaves the residual non-radioactive pieces as non-dissolved. The nitric acid treatment will dissolve the nuclear fuel materials and will leave the structural elements of the SNF assemblies that have been cutup and/or chipped as undissolved and thus the undissolved structural elements of the SNF assemblies that have been cutup and/or chipped are separated from the nitric acid solution with the dissolved the nuclear fuel materials. After execution of step 505, method 500 progresses to step 507 and to step 511.

Continuing discussing FIG. 5, step 507 is a step of chemical processing nitric acid solution output from step 505 to obtain the target goal of the fissile radioactive fuel products. Step 507 is an expensive, complex chemical treating operation in which the output from step 505 is chemically treated to separate and produce the fissile radioactive materials. Step 507 is usually done under extremely safe, highly controlled, remote operational conditions, and it is also a very costly process. The costs of reprocessing the fissile material have been quoted at six times (6X) the cost of sourcing the material from natural mining resources. The complexity and high costs of the prior art methods, such as method 500, are significant reasons that mandate that better, less complicated, inexpensive means of waste processing are required to allow the nuclear power industry to improve and become more productive overall and less cost prohibitive. The current patent application may address this current cost issue. After execution of step 507, method 500 progresses to step 509.

Continuing discussing FIG. 5, step 509 is a step of reprocessing the radioactive products outputted from step 507 for reuse in power generation from nuclear power generators/reactors. Step 509 may be a processing step in which the now recycled radioactive products and fissile elements are remade into the required forms for re-use in nuclear power generation.

Continuing discussing FIG. 5, step 511 is a step of collecting the undissolved assembly structural elements from the step 505. Step 511 may be a relatively simple separation and collection process in which the non-radioactive fragments of the original waste, chipped SNF material 299, are collected. After execution of step 511, method 500 progresses to step 513.

Continuing discussing FIG. 5, step 513 is a step of landfilling or recycling the undissolved assembly structural elements that were collected from step 511.

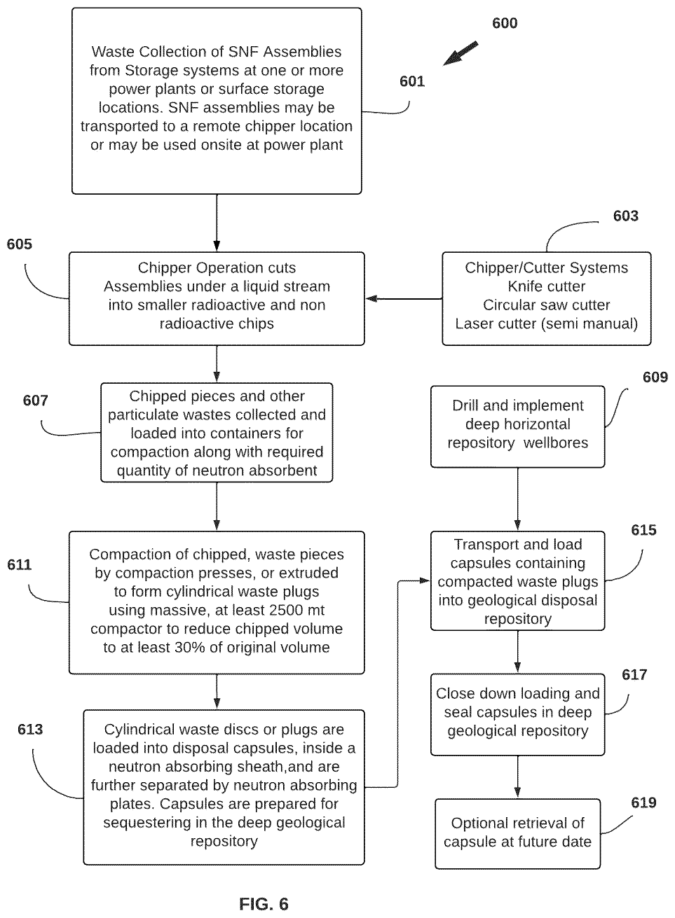

FIG. 6 may depict a flowchart of at least some steps in a method 600. In some embodiments, method 600 may represent a method of mechanically processing SNF assemblies (such as, but not limited to, SNF assemblies 101, 102, and/or 103) for disposing of the processed SNF assemblies in long horizontal wellbores that are implemented in deeply located geological repositories. In some embodiments, method 600 may show at least some of operations or at least some of steps involved in mechanical fragmentation, compression, compaction, extrusion, and/or shaping of the nuclear waste material for subsequent disposal within long horizontal wellbores that are implemented in deeply located geological repositories. In some embodiments, method 600 may be a method of disposing of the encapsulated waste pucks 405 into repositories that are located in deep geological formations. In some embodiments, method 600 may comprise at least one step selected from: step 601, step 603, 605, step 607, step 609, step 611, step 613, step 615, step 617, and/or step 619. In some embodiments, one or more of these steps may be: executed out of numerical order, omitted, skipped, and/or optional.

Continuing discussing FIG. 6, in some embodiments, method 600 may begin with step 601. In some embodiments, step 601 may be a step of collecting SNF assemblies (such as, but not limited to, SNF assemblies 101, 102, and/or 103) for use in method 600. In some embodiments, these SNF assemblies (such as, but not limited to, SNF assemblies 101, 102, and/or 103) may be found in temporary storage in (surface) cooling ponds and/or in surface (or near surface) storage in dry cask containers. In some embodiments, execution of step 601 (and/or of step 603, step 607, step 611, and/or step 613) may be done onsite at a given nuclear power plant (with cooling ponds) in a specialized area of the grounds of that given nuclear power plant. In some embodiments, the collected SNF assemblies (such as, but not limited to, the SNF assemblies 101, 102, and/or 103) may be transported offsite from the temporary storage locations (e.g., cooling ponds and/or dry cask containers) to remote and/or different site(s) for further operations of method 600. In some embodiments, step 601 may be a step of locating and/or identifying the SNF assemblies (such as, but not limited to, SNF assemblies 101, 102, and/or 103) from multiple power plant sites, cooling pond's locations, and/or dry cask containers locations. In this type of multi-plant/multi-location operation, step 601 may be a means of accumulating and commingling various quantities of the SNF assemblies (such as, but not limited to, SNF assemblies 101, 102, and/or 103) for mechanical processing at one or more centrally located site(s), according to further steps of method 600. This approach may increase efficiencies and lower operational costs, and personnel needs for disposal of SNF assemblies (such as, but not limited to, SNF assemblies 101, 102, and/or 103). In some embodiments, at least partial completion of step 601 may progress method 600 to step 605.

Continuing discussing FIG. 6, in some embodiments, step 605 may be a step of mechanically chipping, cutting, shredding, grinding, ripping, tearing, and/or the like the SNF assemblies (such as, but not limited to, SNF assemblies 101, 102, and/or 103) that were collected and/or transported in step 601, into smaller, more manageable pieces of materials, designated, the chipped SNF material 299.

Note, in some embodiments, reference numeral “603” may feed into step 605. In some embodiments, reference numeral “603” may indicate one or more of available technologies, tools, machines, and/or systems that may be configured for one or more of: chipping, cutting, shredding, grinding, ripping, tearing, and/or the like of the SNF assemblies (such as, but not limited to, SNF assemblies 101, 102, and/or 103) into smaller more manageable pieces of materials, the chipped SNF material 299. In some embodiments, options 603 may comprise chipper machine/system 200, chipper machine/system 250, and/or the like. In some embodiments, with respect to options 603, these chipper or mechanical fragmentation systems may be either a single assembly or a combination of chipper/cutter assemblies, knife cutters, circular saw systems, semi-manual laser cutters, laser cutters, shredders, grinders, industrial machines/systems for reducing size of metal feed stock, portions thereof, combinations thereof, and/or the like. Many of these chipper/cutting systems noted in options 603 are currently available in the industry today and have been used for the SNF assemblies chipping purposes at SELLAFIELD operations in the U.K. and ORANO operations in France.

Continuing discussing FIG. 6, in some embodiments, chipper machine/system 200, chipper machine/system 250, other options 603, and/or the like may be used to execute step 605. In the chipping/cutting process of step 605, chipper and/or the like systems identified in options 603 may be utilized to mechanically break down, fragment, chip, cut, shred, grind, rip, tear, and/or the like of the SNF assemblies (such as, but not limited to, SNF assemblies 101, 102, and/or 103) and its components into smaller pieces of fragments, the chipped SNF material 299, which are required for further mechanical processing (modification) according to this method 600. In some embodiments, step 605 may progress to step 607.

Continuing discussing FIG. 6, in some embodiments, step 607 may be a step of collecting the chipped SNF material 299, which may be an output from step 605. In some embodiments, the output of step 605, the chipped SNF material 299, may include (comprise) both radioactive and non-radioactive fragments. In some embodiments, the output of step 605, the chipped SNF material 299, may include (comprise) both fragmented radioactive spent nuclear fuel pellets/elements and fragmented non-radioactive structural elements (e.g., metals, steel, and the like) from the given SNF assemblies. In this step 607, the collected chipped SNF materials 299, may be loaded into container(s) 401 (or the like) for further mechanical processing (modification) according to step 611. Continuing step 607, a required amount of neutron-absorbing material may be added to the chipped material 405. The type and quantity of absorbent is determined from a fissile criticality analysis. This is a standard type of technical analysis in the nuclear waste industry and is well-established. The specific neutron-absorbing material may be selected from the available sources. However, for this application, the required amount of powdered boron carbide is the recommended absorbent. The boron powder may be easily added and distributed throughout the chipped particulate matter 405 of SNF assemblies.

In some embodiments, different types of nuclear and/or radioactive waste material in particulate form may be processed (modified) by method 600 and/or the teachings of this patent application. In some embodiments, different types of nuclear and/or radioactive waste material in particulate form may be may be diverse and in one or more of the following forms: the chipped SNF material 299; shredded metal materials; shredded depleted uranium projectile uranium penetrators; particulate waste from (nuclear) weapons programs such as granulated activated carbon (GAC) produced at the Hanford, WA, remediation operations; also existing powder material such as uranium oxide powder may be treated and disposed of in the same manner; portions thereof; combinations thereof; and/or the like. In some embodiments, one or more of this diverse set of nuclear and/or radioactive waste materials may be processed (modified) and/or disposed of per method 600 and/or the teachings of this patent application, similar to how the chipped SNF material 299 may be processed (modified) and/or disposed of. In some embodiments, step 607 may progress to step 611.

Continuing discussing FIG. 6, in some embodiments, step 611 may be a step of compressing, compacting, extruding, and/or shaping the chipped SNF material 299 (and/or the other nuclear and/or radioactive waste forms noted above in step 607) into the outputted waste pucks 405 (discs 330 and/or discs 380). In some embodiments, step 611 may be executed, at least in part, by compactor machine 300, compactor machine 350, combinations thereof, and/or the like. In some embodiments, step 611 may be executed according to the teaching of FIG. 3A to FIG. 4C, portions thereof, combinations thereof, and/or the like. In some embodiments, the nuclear and/or radioactive waste feed materials that may be fed into compactor machine 300, compactor machine 350, combinations thereof, and/or the like may be selected from one or more of: the chipped SNF material 299; shredded metal materials; shredded depleted uranium projectile uranium penetrators; particulate waste from nuclear weapons programs; uranium oxide powder; portions thereof, combinations thereof; and/or the like. In some embodiments, the nuclear and/or radioactive waste output materials exiting from compactor machine 300, compactor machine 350, combinations thereof, and/or the like may be waste pucks 405 (discs 330 and/or discs 380). In some embodiments, during execution of step 611, the feed material (such as, but not limited to, the chipped SNF material 299) may compressed and/or compacted to at least twenty percent (20%) plus or minus (+/−) five percent of (5%) of the original (non-compressed) volume. In some embodiments, during execution of step 611, the feed material (such as, but not limited to, the chipped SNF material 299) may compressed and/or compacted to at least thirty percent (30%) plus or minus (+/−) five percent of (5%) of the original (non-compressed) volume. In other embodiments the amount of original volume reduction may be another value. In some embodiments, compactor machine 300, compactor machine 350, combinations thereof, and/or the like may be configured to achieve a minimum percentage in original volume reduction of the feed material. In some embodiments, during execution of step 611, the feed material (such as, but not limited to, the chipped SNF material 299) may be continuously fed into the given compactor machine 300, compactor machine 350, combinations thereof, and/or the like by a feeder system, not shown. In some embodiments, this feeder feature addition may allow for more efficient and/or rapid preparation (modification) the feed material (such as, but not limited to, the chipped SNF material 299) since production of waste pucks 405 (discs 330 and/or discs 380) can run almost automatically and continuously, only being limited by availability of the feed material and/or shutdowns for maintenance. In some embodiments, during execution of step 611, a relatively small amount of spray-type binder substance, adhesive product, or the like, may be added to the shredded and/or chipped feed material (such as, but not limited to, the chipped SNF material 299) to allow for better binding and coalescing of the feed material while under compression, compaction, extrusion, and/or shaping. In some embodiments, during execution of step 611, an industrial release agent may be used on interior/inside surfaces of compactor machine 300, compactor machine 350, combinations thereof, and/or the like, to facilitate and/or improve release and/or ejection of waste pucks 405 (discs 330 and/or discs 380) after compression, compaction, extrusion, and/or shaping processes are completed. In some embodiments, during execution of step 611, subassembly 360 and/or extruder subassembly 370 of a given compactor machine 350 may be fed the feed material (such as, but not limited to, the chipped SNF material 299) and may selectively and/or (continuously) extrude the waste pucks 405 (discs 380), which depending upon the extrusion ejection nozzle shape may be shaped at least substantially as cylindrical discs, plugs, and/or pucks, or as bricks or briquettes. In some embodiments, outputted waste pucks 405 (discs 330 and/or discs 380) may be organized and/or collected as plurality of waste discs 390, which may comprise two or more waste pucks 405 (discs 330 and/or discs 380). In some embodiments, step 611 may progress to step 613. See also, FIG. 3A to FIG. 4C for figures relevant to compression, compaction, extrusion, and/or shaping operations of the feed material (such as, but not limited to, the chipped SNF material 299).

Continuing discussing FIG. 6, in some embodiments, step 613 may be a step of packaging, loading, filling, inserting, placing, and/or the like the waste pucks 405 (discs 330 and/or discs 380) into a waste capsule 409 (recall FIG. 4D for waste capsule 409) or into at least one waste capsule 409 or into one or more waste capsules 409 or into a plurality of waste capsules 409. In some embodiments, with respect to step 613, the nuclear waste puck(s) 405 may be loaded into waste capsule(s) 409. In some embodiments, implemented within waste capsule 409 may be an inner neutron-absorbing sheath 411, comprised of a material such as borated steel material (and/or the like), which absorbs the neutron radiation from the waste puck(s) 405. In some embodiments, this (boron) sheath 411 may provide an outer covering surrounding the radioactive material of waste puck(s) 405. In some embodiments, in addition to the (boron metallic) sheath 411, the waste pucks 405 may also be separated from each other within a given waste capsule 409 by neutron-absorbing (separator) plate(s) 410. In some embodiments, such (boron) (separator) plate(s) 410 may be inserted between the waste pucks 405 (within a given waste capsule 409). In some embodiments, a given waste capsule 409 may comprise at least one waste puck 405 (disc 330 and/or disc 380). In some embodiments, a given waste capsule 409 may comprise at least two waste pucks 405 (discs 330 and/or discs 380). In some embodiments, a given waste capsule 409 may comprise a plurality of waste pucks 405 (discs 330 and/or discs 380). In some embodiments, a given waste capsule 409 may comprise a plurality of waste discs 390). In some embodiments, step 613 may progress to step 615.

Continuing discussing FIG. 6, in some embodiments, step 615 may be a step of transporting, loading, and/or sequestering the filed waste capsules 409 of step 613 into a given deeply located geological repository. In some embodiments, at least one waste filled waste capsule 409 may be initially (first) inserted into a given wellbore with an entrance at terrestrial level (at the Earth's surface), wherein this wellbore may continue at least substantially (mostly) vertically downwards until reaching at least one target deeply located geological formation, wherein that wellbore may then transition into at least a substantially (mostly) horizontal (lateral) run of the wellbore within that at least one target deeply located geological formation, such that the inserted at least one waste filled waste capsule 409 may come to a final resting location within a section of the wellbore that is within the at least one target deeply located geological formation. In some embodiments, a given deeply located geological repository may comprise wellbore(s) within at least one target deeply located geological formation. In some embodiments, when there may be two or more waste filled waste capsules 409 that are ready for placement into the deeply located geological repository, those two or more waste filled waste capsules 409 may be mechanically and/or physically linked together, in an end-to-end fashion, as shown in FIG. 4F, via interactions between two adjacent capsule connector devices 406 of two different waste filled waste capsules 409, to form a given string of waste filled waste capsules 414 (see e.g., FIG. 4F). In some embodiments, step 615 may progress to step 617.

Continuing discussing FIG. 6, in some embodiments, step 609 may be a step of implementing, drilling, forming, constructing, building portions thereof, combinations thereof, and/or the like at least one deeply located geological repository that is configured to receive at least one at least one waste filled waste capsule 409. In some embodiments, step 609 may progress to step 615.

Continuing discussing FIG. 6, in some embodiments, step 617 may be a step of closing and sealing a deeply located geological repository that has received at least one waste filled waste capsule 409. In some embodiments, step 617 may progress to step 619.

Continuing discussing FIG. 6, in some embodiments, step 619 may be an optional step of retrieving at least one waste capsules 409 from the deeply located geological repository at a later date for later use.

FIG. 7 may depict a waste disposal repository system 700 in which waste capsules 409 (with waste pucks 405) are sequestered in horizontal wellbore(s) 701, wherein the horizontal wellbore(s) 701 are located within deeply located geological formation(s) 415 (wherein a waste disposal repository system 700 that uses such horizontal wellbore(s) 701 that are located within deeply located geological formation(s) 415 may be referred to as a SuperLAT deep disposal system 700). FIG. 7 may depict a partial cutaway view of a system 700 for (long-term) disposing of nuclear, radioactive, hazardous, and/or dangerous waste, such as, but not limited to, waste pucks 405, within waste capsules 409, wherein such loaded waste capsule(s) may be emplaced within horizontal (lateral) wellbore(s) 701, wherein at least some section(s) (portion(s) and/or region(s)) of the horizontal (lateral) wellbore(s) 701 may be located within at least one deeply located geologic formation (rock) 415. In some embodiments, each horizontal (lateral) wellbore 701 may be operatively connected to at least one vertical wellbore 703. In some embodiments, lengths of a pair of operatively connected horizontal (lateral) wellbore 701 section and vertical wellbore 703 section may be at least substantially (mostly) orthogonal (perpendicular) to each other. In some embodiments, the vertical wellbore 703 (that is operatively connected to a section of horizontal [lateral] wellbore 701) may run from that section of horizontal (lateral)wellbore 701 (vertically) to a terrestrial (Earth) surface 705. In some embodiments, terrestrial (Earth) surface 705 may be an above ground local terrestrial surface of the Earth, wherein a given vertical wellbore 703 may originate at and descend (vertically) downwards into at least one deeply located geologic formation (rock) 415, which that wellbore may then change directions into the horizontal (lateral) direction to form at least one horizontal (lateral)wellbore 701 located within that at least one deeply located geologic formation (rock) 415. In some embodiments, “vertical” in the context of vertical wellbore 703, may mean that a given vertical wellbore 703 has a length that runs in a direction that is at least substantially (mostly) parallel with a local gravitational vector (local to that given vertical wellbore 703). In some embodiments, at a given well head site, using a given drilling rig 707, from terrestrial (Earth) surface 705, first a given vertical wellbore 703 may be formed and drilled to at least a depth of and into the at least one deeply located geologic formation (rock) 415; and then, using a given drilling rig 707, that wellbore may then change directions into the horizontal (lateral) direction to form at least one horizontal (lateral)wellbore 701 located within that at least one deeply located geologic formation (rock) 415.

Continuing discussing FIG. 7, in some embodiments, drilling rig(s) 707, from surface 705, may be used to form wellbore(s) 701, 703, and/or 412. In some embodiments, drilling rig(s) 707 using downhole tools and techniques, from surface 705, may be used to land, emplace, load, insert, place, and/or the like waste capsule(s) 409 (with waste pucks 405 within) and/or string(s) of waste capsules 414 (with waste pucks 405 within) within wellbore(s) 701, 703, and/or 412. In some embodiments, drilling rig(s) 707 using downhole tools and techniques, from surface 705, may be used to retrieve waste capsule(s) 409 (with waste pucks 405 within) and/or to retrieve string(s) of waste capsules 414 (with waste pucks 405 within) from within wellbore(s) 701, 703, and/or 412. In some embodiments, drilling rig 707 may be at least substantially similar to a drilling rig used to form and/or case wellbores in oil and/or gas fields. In some embodiments, forming wellbore(s) 701, 703, and/or 412, as well as, handling waste capsule(s) 409 and/or string(s) of waste capsule(s) 414, within wellbore(s) 701, 703, and/or 412, may be accomplished using drilling rigs, tools, tooling, machines, devices, apparatus, systems, methods, processes, and/or techniques of the oil field industry that are in use today and well understood. Such preexisting downhole drilling rigs, tools, tooling, machines, devices, apparatus, systems, methods, processes, and/or techniques of the oil field industry are incorporated by reference herein as if fully set forth herein.

Continuing discussing FIG. 7, in some embodiments, deeply located geologic formation (rock) 415. In some embodiments, suitable deeply located geologic formation(s) (rock(s)) 415 may be located at least 5,000 feet (ft) below the surface 705, plus or minus 100 feet (ft). In some embodiments, deeply located geologic 415 may have a vertical thickness between fifty (50) feet (plus or minus ten feet) and 1,000 feet (plus or minus fifty feet). In some embodiments, deeply located geologic formation(s) (rock(s)) 415 may be of geological formations selected from tight shales, deeply bedded salt formations, deep bed-rock granite formations, portions thereof, combinations thereof, and/or the like. These types of geological formations usually (typically and/or often) all have very limited permeability and very low intrinsic water saturations, which contribute to be suitable geologic formations for deeply located geologic formation(s) (rock(s)) 415 that may accommodate long-term storage (disposal) of dangerous wastes therein with risking harm to the exterior ecosphere.

Continuing discussing FIG. 7, in some embodiments, located local to, adjacent to, and/or proximate to a given vertical wellbore 703 wellhead, on terrestrial (Earth) surface 705, may be at least one nuclear power generation reactor plant 709. In some embodiments, located onsite to a given vertical wellbore 703 wellhead, on terrestrial (Earth) surface 705, may be at least one nuclear power generation reactor plant 709. In some embodiments, operation of nuclear power generation reactor plant 709 may yield electrical power, typically for grid distribution and may also yield SNF that requires safe, efficient, and cost-effective long-term disposal, such as, but not limited to, disposal within a given waste repository system 700. In some embodiments, located, local to, adjacent to, and/or proximate to a given vertical wellbore 703 wellhead, on terrestrial (Earth) surface 705, may be at least one infrastructure building or structure 711. In some embodiments, located onsite to a given vertical wellbore 703 wellhead, on terrestrial (Earth) surface 705, may be at least one infrastructure building or structure 711. In some embodiments, infrastructure building or structure 711 may comprise one or more of: SNF cooling pools, SNF cooling ponds, SNF temporary storage casks, control rooms, operations rooms, warehouses, maintenance and engineering workshops, offices, and/or other building(s) and/or structures typical to have at a nuclear power generation reactor plant 709 site. In this context of surface 705 structure(s), objects, and/or building(s) of a particular nuclear power generation reactor plant 709 site, SNF cooling pond(s)/pool(s) site, SNF temporary storage site, and/or system 700 site, “local,” “onsite,” “adjacent,” and/or “proximate” may be five (5) miles or less.

Continuing discussing FIG. 7, in some embodiments, after a given horizontal (lateral) wellbore 701 has been at least partially to fully filled with waste capsules 409 (containing waste pucks 405), that given repository system 700 may be sealed (closed off) by placing at least one plug 713 within a section of vertical wellbore 703, that operatively connects to that at least partially filled horizontal (lateral) wellbore 701. In some embodiments, plug 713 may be at least partially made from concrete, steel, and/or rock 415 material. In some embodiments, an emplaced plug 713, within a given wellbore 703, may close off that wellbore system, from liquid (water) and/or mechanical/particulate intrusion and/or migration issues.

In some embodiments, a given nuclear, radioactive, hazardous, and/or dangerous waste repository system 700 (SuperLAT system 700) may comprise at least one of (one or more of): at least one horizontal (lateral) wellbore 701 located (entirely) within at least one deeply located geologic formation (rock) 415, at least one vertical wellbore 703 that may operatively connect to that at least one horizontal (lateral) wellbore 701 and that may run from that at least one horizontal (lateral) wellbore 701 to surface 705; at least one waste capsule 409 (with at least one waste puck 405 located within that at least one waste capsule 409); at least one emplaced plug 713 located withing that at least one vertical wellbore 703; at least one drilling rig 707; at least one nuclear power generation reactor plant 709 (operational, non-operational, and/or decommissioned); at least one infrastructure building or structure 711; combinations thereof; and/or the like.

In some embodiments, method 600 may be a method of disposing of SNF assemblies and/or other nuclear waste forms. In some embodiments, method 600 may comprise at least steps of: step (a), step (b), step (c), and step (d).

In some embodiments, step (a) may be a step of reducing a size of a (intact) SNF assembly or a portion thereof into chips 299 by chipping, cutting, shredding, and/or grinding the spent nuclear fuel assembly or the portion thereof, using at least one chipper machine, such as, but not limited to, chipper machine 200, chipper machine 250, portions thereof, combinations thereof, and/or the like. See e.g., step 603. In some embodiments, step (a) may be at least substantially (mostly) similar to step 603 or identical to step 603. In some embodiments, other forms of radioactive waste may be fed into the at least one chipper machine 200/250 (or the like) during execution of the step (a) that contributes to generation of the chips 299. In some embodiments, the other forms of radioactive waste may be selected from at least one of: radioactive metal materials; depleted uranium penetrators; waste from nuclear weapons programs; uranium oxide powder; portions thereof; combinations thereof; and/or the like.

In some embodiments, prior to execution of the step (a), method 600 may comprise a step of collecting at least some of the SNF assemblies to one or more sites. In some embodiments, at least the step (a) and the step (b) may be executed at (onsite) the one or more sites. In some embodiments, the at least some of the SNF assemblies may be collected from cooling ponds and/or from dry casks. In some embodiments, at least one site selected from the one or more sites may be a nuclear power plant. See e.g., step 601.

In some embodiments, step (b) may be a step of compressing the chips 299 into pucks 405 using at least one compactor machine 300/350. See e.g., step 611. In some embodiments, step (b) may be at least substantially (mostly) similar to step 611 or identical to step 611. In some embodiments, execution of the step (b) may result in at least a thirty percent (30%) reduction in an original volume of the chips 299 that are fed into the at least one compactor machine 300/350 (or the like). In some embodiments, the “original volume” of the chips 299 may refer to a volume of the chips 299 before the chips 299 are modified according to the step (b) (step 611). In some embodiments, the step (b) compressing may further comprises compacting the chips 299 into the pucks 405 using the at least one compactor machine 300/350 (or the like). In some embodiments, during the execution of the step (b), a feeder may be used to automatically or semiautomatically feed the chips 299 into the at least one compactor machine 300/350 (or the like). In some embodiments, the step (b) compressing may further comprise extruding the chips 299 that have been compressed into the pucks 405 using the at least one compactor machine 300/350 (or the like), wherein the pucks 405 may be shaped by the extruding. In some embodiments, the at least one compactor machine 300/350 (or the like) may have compression, compacting, extrusion, and/or shaping functionality with respect to its outputted waste pucks 405. In some embodiments, the outputted pucks 405 from the step (b) (step 611) may have a predetermined shape that is selected from at least one of: a solid cylindrical disc shape, a solid brick shape, a solid briquette shape, and/or the like. See e.g., step 611, and FIG. 3A through FIG. 4C, and FIG. 6.

In some embodiments, method 600 may not utilize a chemical treatment of the chips 299, aside from during execution of the step (b): of the method 600 optionally using a binding agent on at least some of the chips 299 and/or the method 600 optionally using a release agent on the at least one compactor machine 300/350. In some embodiments, method 600 may not utilize an acidic chemical treatment of the chips 299. In some embodiments, method 600 may not utilize a nitric acid chemical treatment of the chips 299. In some embodiments, with respect to the chips 299, method 600 may not separate radioactive materials from non-radioactive materials because method 600 is not trying to generate nuclear fuel; rather, method 600 is physically modifying nuclear waste forms for disposal within lateral wellbores that re located deeply within geologic repositories.

In some embodiments, step (c) may be a step of loading at least some of the pucks 405 into at least one waste capsule 409. See e.g., step 613. In some embodiments, step (c) may be at least substantially (mostly) similar to step 613 or identical to step 613.

In some embodiments, the at least one waste capsule 409 may be a rigid, hollow, elongate, cylindrical member of fixed and finite length with two opposing terminal ends and surrounding a volume of void space, wherein at least some of the volume of void space is configured for receiving the at least some of the pucks 405, wherein the two opposing terminal ends are configured to be closed. See e.g., FIG. 4D.

In some embodiments, the volume of void space is shaped and sized, and the pucks 405 are shaped and sized, such that during execution of the step (c) the at least some of the pucks 405 may be loaded into the volume of void space in a serial fashion, with one puck 405 on top of another puck 405, aside from a first loaded puck 405 that is butted up against one of the two opposing terminal ends that is closed. See e.g., FIG. 4D.

In some embodiments, at each of the two opposing terminal ends of the at least one waste capsule 409 may be a connector device 406 that is configured to mechanically and physically link to a connector device 406 of a different waste capsule 409, such that two or more waste capsules 409, selected from the at least one waste capsule 409, are mechanically and physically linked together into a string of waste capsules 409. See e.g., FIG. 4E.

In some embodiments, step (d) may be a step of landing the at least one waste capsule 409 within a section of wellbore that is deeply located within a geological formation. See e.g., step 615. In some embodiments, step (d) may be at least substantially (mostly) similar to step 615 or identical to step 615.

In some embodiments, the section of the wellbore, that is deeply located within the geological formation, may run in a substantially horizontal direction that is substantially orthogonal to a local gravitational vector along the section of the wellbore. In some embodiments, the section of the wellbore is operatively linked to a different section of the wellbore, wherein the different section runs from the geological formation upwards to a terrestrial surface. In some embodiments, the different section of the wellbore runs in a substantially vertical direction that is substantially orthogonal to the section of the wellbore. See e.g., FIG. 7.

In some embodiments, after execution of the step (d), method 600 may further comprise a step of sealing off and closing the wellbore. See e.g., step 617.

In some embodiments, method 600 may further comprise a step of unsealing and reopening the wellbore. In some embodiments, method 600 may further comprise a step of retrieving a waste capsule 409, selected from the at least one waste capsule 409, from the section of the wellbore. See e.g., step 619.

Devices, systems, and methods for mechanical and/or physical modifications of nuclear waste forms, such as, but not limited to, spent nuclear fuel (SNF) assemblies, for disposing within deeply located geologic repositories have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of disposing of spent nuclear fuel assemblies comprising steps of:
(a) reducing a size of a spent nuclear fuel assembly or a portion thereof into chips by chipping, cutting, shredding, and/or grinding the spent nuclear fuel assembly or the portion thereof, using at least one chipper machine;
(b) compressing the chips into pucks using at least one compactor machine;
(c) loading at least some of the pucks into at least one waste capsule; and
(d) landing the at least one waste capsule within a section of wellbore that is deeply located within a geological formation.

2. The method according to claim 1, wherein the method does not utilize a chemical treatment of the chips, aside from during execution of the step (b): the method optionally uses a binding agent on at least some of the chips and/or the method optionally uses a release agent on the at least one compactor machine.

3. The method according to claim 1, wherein the method does not utilize an acidic chemical treatment of the chips.

4. The method according to claim 1, wherein the method does not utilize a nitric acid chemical treatment of the chips.

5. The method according to claim 1, wherein with respect to the chips, the method does not separate radioactive materials from non-radioactive materials.

6. The method according to claim 1, wherein other forms of radioactive waste are fed into the at least one chipper machine during execution of the step (a) that contributes to generation of the chips, wherein the other forms of radioactive waste are selected from at least one of: radioactive metal materials; depleted uranium penetrators; waste from nuclear weapons programs; or uranium oxide powder.

7. The method according to claim 1, wherein prior to execution of the step (a), the method comprises a step of collecting at least some of the spent nuclear fuel assemblies to one or more sites, wherein at least the step (a) and the step (b) are executed at the one or more sites.

8. The method according to claim 7, wherein the at least some of the spent nuclear fuel assemblies are collected from cooling ponds and/or from dry casks.

9. The method according to claim 7, wherein at least one site selected from the one or more sites is a nuclear power plant.

10. The method according to claim 1, wherein execution of the step (b) results in at least a thirty percent reduction in an original volume of the chips that are fed into the at least one compactor machine.

11. The method according to claim 1, wherein the step (b) compressing further comprises compacting the chips into the pucks using the at least one compactor machine.

12. The method according to claim 1, wherein during the execution of the step (b), a feeder is used to automatically or semiautomatically feed the chips into the at least one compactor machine.

13. The method according to claim 1, wherein the step (b) compressing further comprises extruding the chips that have been compressed into the pucks using the at least one compactor machine, wherein the pucks are shaped by the extruding.

14. The method according to claim 13, wherein the pucks have a predetermined shape that is selected from at least one of: a solid cylindrical disc shape, a solid brick shape, or a solid briquette shape.

15. The method according to claim 1, wherein the at least one waste capsule is a rigid, hollow, elongate, cylindrical member of fixed and finite length with two opposing terminal ends and surrounding a volume of void space, wherein at least some of the volume of void space is configured for receiving the at least some of the pucks, wherein the two opposing terminal ends are configured to be closed.

16. The method according to claim 15, wherein the volume of void space is shaped and sized, and the pucks are shaped and sized, such that during execution of the step (c) the at least some of the pucks are loaded into the volume of void space in a serial fashion, with one puck on top of another puck, aside from a first loaded puck that is butted up against one of the two opposing terminal ends that is closed.

17. The method according to claim 15, wherein at each of the two opposing terminal ends of the at least one waste capsule is a connector device that is configured to mechanically and physically link to a connector device of a different waste capsule, such that two or more waste capsules, selected from the at least one waste capsule, are mechanically and physically linked together into a string of waste capsules.

18. The method according to claim 1, wherein the section of the wellbore, that is deeply located within the geological formation, runs in a substantially horizontal direction that is substantially orthogonal to a local gravitational vector along the section of the wellbore.

19. The method according to claim 18, wherein the section of the wellbore is operatively linked to a different section of the wellbore, wherein the different section runs from the geological formation upwards to a terrestrial surface.

20. The method according to claim 19, wherein the different section of the wellbore runs in a substantially vertical direction that is substantially orthogonal to the section of the wellbore.

21. The method according to claim 1, wherein after execution of the step (d), the method further comprises a step of sealing off and closing the wellbore.

22. The method according to claim 21, wherein the method further comprises a step of unsealing and reopening the wellbore.

23. The method according to claim 22, wherein the method further comprises a step of retrieving a waste capsule, selected from the at least one waste capsule, from the section of the wellbore.
